(19) United States
(12) Patent Application Publication
(10) Pub. No.: US 2014/0159393 A1
(43) Pub. Date: Jun. 12, 2014

(54) DOOR STRIKER MOUNTING APPARATUS FOR VEHICLE

(71) Applicant: Hyundai Motor Company, Seoul (KR)

(72) Inventor: Chul Hee HEO, Anyang-si (KR)

(21) Appl. No.: 13/916,216

(22) Filed: Jun. 12, 2013

(30) Foreign Application Priority Data
Dec. 11, 2012 (KR) 10-2012-0143267

(51) Int. Cl. E05B 15/02

(52) U.S. Cl. CPC E05B 15/0205
USPC 292/340

(57) ABSTRACT

A door striker mounting apparatus for a vehicle includes a door striker, a mounting bracket, and a mounting plate. The door striker is disposed on an outer side member of a vehicle body. The mounting bracket is disposed between an outer center pillar reinforcing member of the vehicle body and the outer side member. The mounting plate is disposed on the mounting bracket so as to contact a central portion of the mounting bracket, wherein the central portion of the mounting bracket also contacts a portion of the outer side member having the door striker mounted thereon. The door striker, the outer side member, the central portion of the mounting bracket, and the mounting plate are attached together, and the central portion of the mounting bracket is spaced away from the outer center pillar reinforcing member.

### CROSS-REFERENCE TO RELATED APPLICATION

This application claims the benefit under 35 U.S.C. §119(a) of Korean Patent Application No. 10-2012-0143267 filed Dec. 11, 2012, the entire contents of which are incorporated herein by reference.

### BACKGROUND

(a) Technical Field

The present disclosure relates to an apparatus for mounting a door striker on a center pillar side of a vehicle body such that the door striker can reliably engage with a door latch.

(b) Background Art

In general, a door striker of a vehicle is a member which engages with a latch of a door of the vehicle when the door is closed. The door striker is generally installed to be supported by an outer center pillar reinforcing member of the vehicle body and by an outer side member of the vehicle body.

For example, as shown in FIGS. 1 and 2, the door striker 10 is coupled to a portion of an outer center pillar reinforcing member 12 which overlaps with an outer side member 13, and the door striker 10 is mounted using a mounting plate 11. An angle between a side wall of the door striker 10 and a direction of closing of a vehicle door generally should be maintained to within a 2° margin, as shown in FIG. 2. The outer center pillar reinforcing member 12 provides support to the vehicle in case of a side collision, provides the vehicle body with strength, and maintains the door of the vehicle securely closed as part of having the door striker mounted thereto.

Various structures for mounting a door striker to a vehicle are disclosed in Korean Patent Application Publication No. 2005-5079, Korean Patent Application Publication No. 2003-38842, and U.S. Patent Application Publication No. 2004-56516.

In order to provide an outer center pillar reinforcing member 12 with the strength sufficient to withstand a side collision of the vehicle body, the outer center pillar reinforcing member 12 is generally manufactured using a 980 MPa cold pressing process. In some situations, the outer center pillar reinforcing member 12 can alternatively be formed using a 1200 MPa hot stamping process; however, the use of the hot stamping process considerably increases manufacturing costs. As a result, cold pressing is generally used in the manufacture of light weight vehicles, and the material used to form the outer center pillar reinforcing member 12 thereby corresponds to specifications of the 980 MPa process.

Since an angle between a side wall of the center pillar on which the door striker is mounted and a direction of closing of a vehicle door generally needs to be maintained to within a 2° margin, the center pillar is subject to cracking and/or the formation of fissures during manufacture resulting from the need to adjust or correct the shape of the center pillar so as to ensure that the center pillar meets the 2° margin specification. The cracking and fissuring of the center pillar, however, results in the waste of molds and the lowering of manufacturing productivity.

Ideally, the angle between the side wall of the center pillar on which the door striker is mounted and a closing direction of a door should be within a few degrees. For example, as shown in the left-most portion of FIG. 3, a striker center line crosses a hinge axis (identifying the direction of closing of a vehicle door). The striker center line is perpendicular to the door entry direction, and forms an angle with the outer side reinforcing member that is set to 2°.

In situations in which the angle exceeds 2°, various problems may arise. For example, as shown in the center-left portion of FIG. 3, the mounting angle of a door striker may need to be adjusted; as shown in the center-right portion of FIG. 3, the shape of a striker base may need to be adjusted; and/or, as shown in the right-most portion of FIG. 3, a mounting of a latch and or a striker may need to be adjusted In the examples shown, as a result of a deviation of 87 mm from a hinge axis, a door cannot be opened and closed due to overlapping (by 0.5 mm) of a latch and a striker, assembly of a striker to a vehicle may be complicated due to a discrepancy between the axis of a striker post and a base hole center line, and durability and opening/closing quality of a door assembly may be deteriorated due to a slip between a latch and a striker.

Additionally, when a 980 MPa material is used to form the outer center pillar reinforcing member, variations in the specifications of the door striker and/or of the outer center pillar reinforcing member during mass production can interfere with the ability to properly secure the door striker on the outer center pillar reinforcing member due to the precise requirements on the angle of the side wall of the outer center pillar reinforcing member on which the door striker is mounted.

### SUMMARY OF THE DISCLOSURE

The present disclosure provides a door striker mounting apparatus for a vehicle which provides a new type of door striker mounting structure in which a door striker mounting plate is not directly attached to an outer center pillar reinforcing member of the vehicle, but is instead indirectly attached to the outer center pillar reinforcing member using a separate mounting bracket. The disclosure thus mitigates manufacturing problems relating to a side wall angle of the outer center pillar reinforcing member, and simplifies the mounting and performance of door strikers during mass production.

In accordance with an aspect of the present disclosure, a door striker mounting apparatus for a vehicle includes a door striker disposed on an outer side member of a vehicle body; a mounting bracket disposed between an outer center pillar reinforcing member of the vehicle body and the outer side member of the vehicle body, wherein a central portion of the mounting bracket contacts a portion of the outer side member having the door striker disposed thereon; and a mounting plate disposed on the mounting bracket so as to contact the central portion of the mounting bracket, wherein the door striker, the outer side member, the central portion of the mounting bracket, and the mounting plate are attached together, and wherein the central portion of the mounting bracket is spaced away from the outer center pillar reinforcing member.

In an embodiment of the present disclosure, the mounting bracket is disposed between the outer center pillar reinforcing member and the outer side member such that ends of the mounting bracket are bonded to the outer center pillar reinforcing member, and the central portion of the mounting bracket which contacts the outer side member is spaced away from the outer center pillar reinforcing.

In another embodiment of the present disclosure, the apparatus includes a bolt for attaching the door striker, the outer side member, the central portion of the mounting bracket, and the mounting plate to each other, wherein the outer center pillar reinforcing member includes a bolt avoiding hole formed in the outer center pillar reinforcing member and lined up with a principal axis of the bolt.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 is a perspective view showing a door striker mounting structure according to related art;

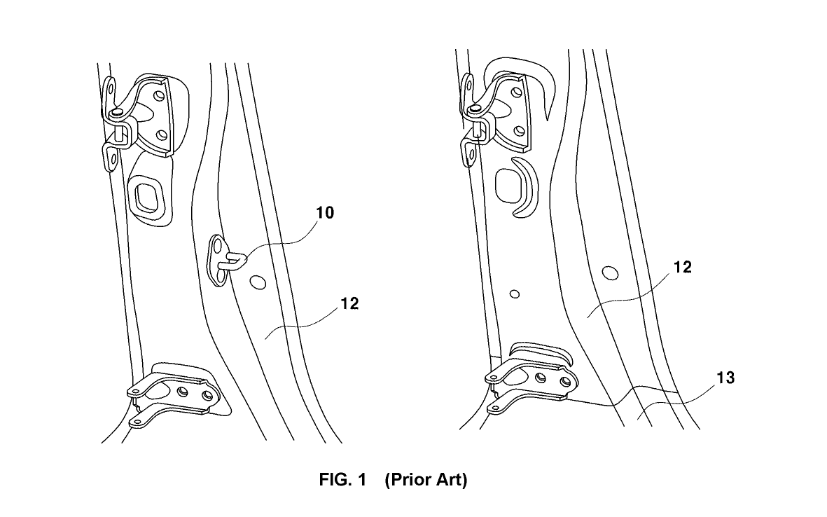

FIG. 2 is a cross-sectional view showing the door striker mounting structure of FIG. 1;

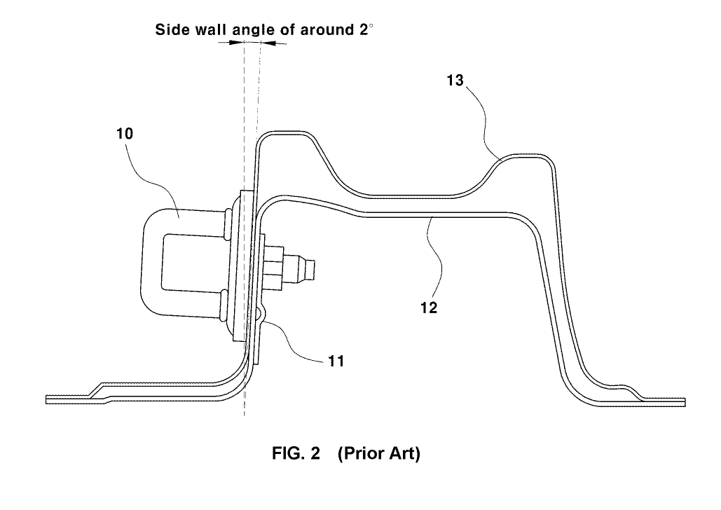

FIG. 3 shows schematic diagrams of various examples relating to shortcomings of door striker mounting structures according to related art;

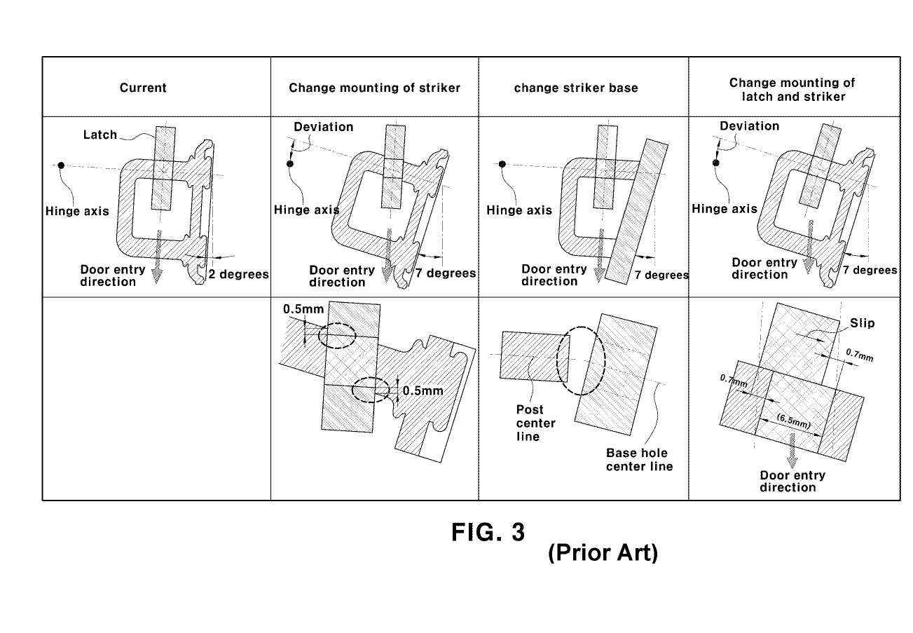

FIG. 4 is a perspective view showing a door striker mounting apparatus according to an exemplary embodiment of the present disclosure; and

FIG. 5 is a cross-sectional view showing the door striker mounting apparatus of FIG. 4.

It should be understood that the appended drawings are not necessarily to scale, and present a somewhat simplified representation of various features illustrative of the basic principles of the disclosure. The specific design features of the present disclosure as disclosed herein, including, for example, specific dimensions, orientations, locations, and shapes, may be adjusted based on the particular intended application and use environment.

In the figures, the same reference numbers refer to similar or equivalent parts throughout the several figures.

### DETAILED DESCRIPTION

Hereinafter, an exemplary embodiment of the present disclosure will be described in detail with reference to the accompanying drawings.

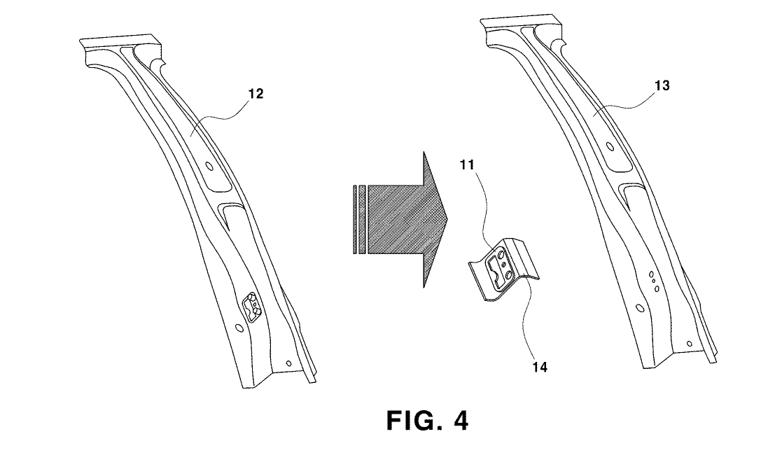

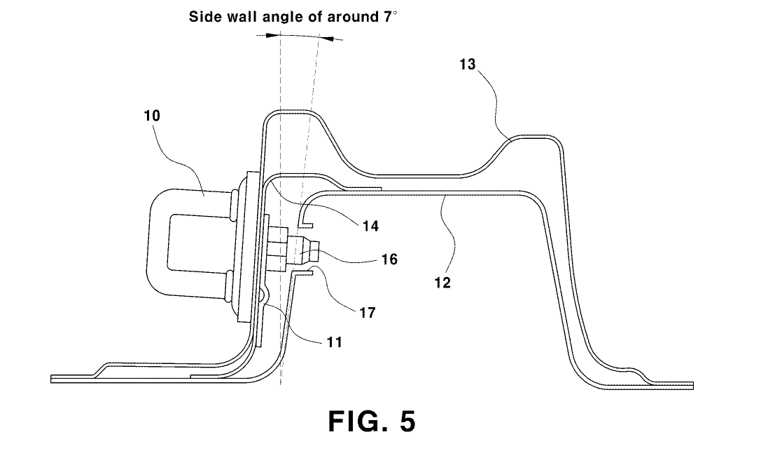

FIG. 4 is a perspective view showing a door striker mounting apparatus according to an exemplary embodiment of the present disclosure. FIG. 5 is a cross-sectional view showing a door striker mounting apparatus such as that shown in FIG. 4.

As shown in FIGS. 4 and 5, the door striker mounting apparatus includes a structure in which a door striker mounting part is spaced away from an outer center pillar reinforcing member 12 to mitigate problems caused by variations in the angle of a side wall of the outer center pillar reinforcing member 12.

The door striker 10 may be supported by an outer side member 13 having a side wall that is angled approximately 2° with respect to a direction of closing of a vehicle door, such that a center line of the door striker 10 crosses a hinge axis of the vehicle door and is perpendicular to a door entry direction. In such a situation, the resulting positioning of the door striker 10 may providing for proper opening/closing performance of the vehicle door, proper functioning of the striker 10, durability of the striker and latch assemblies, and secure opening/closing quality of the vehicle door.

An outer side member 13 and an outer center pillar reinforcing member 12 of a vehicle are disposed on outer and inner sides of the vehicle body. The outer side member 13 and outer center pillar reinforcing member 12 are attached together, for example by bonding ends of the outer side member 13 and ends of the outer center pillar reinforcing member 12 to each other through welding. The interconnected outer side member 13 and outer center pillar reinforcing member 12 can create a closed sectional space between each other, as shown in the cross-sectional view of FIG. 5.

In general, the outer side member 13 can maintain a side wall angle of approximately 2°, independently of a side wall angle of the outer center pillar reinforcing member 12. For example, as shown in FIG. 5, the outer side member 13 can maintain a side wall angle of approximately 2° even though the outer center pillar reinforcing member 12 has a side wall angle of around 7°.

A mounting bracket 14 is provided in the space formed between the outer side member 13 and outer center pillar reinforcing member 12. The mounting bracket 14 provides a means for securely mounting the door striker 10 to the vehicle regardless of the positioning of the outer center pillar reinforcing member 12.

As shown in the cross-sectional view of FIG. 5, opposite ends of the mounting bracket 14 are bent by approximately 90°. The mounting bracket 14 can correspond to a rectangular plate shape, as shown in FIG. 4. When mounted to the outer side member 13 and to the outer center pillar reinforcing member 12, a central portion of the mounting plate 14 contacts the outer side member 13 in a region of the outer side member 13 supporting the door striker 10. The central portion of the mounting plate 14 further contacts the mounting plate 11. In particular, opposite sides of the central portion of the mounting plate 14 may respectively contact the outer side member 13 and the mounting plate 11. The ends of the mounting plate 14 are fixed to the outer center pillar reinforcing member 12 for example by welding, as shown in FIG. 5.

That is, the door striker 10 is mounted to the outer side member 13, to the central portion of the mounting bracket 14, and to the mounting plate 11. A bolt 16 may be used to securely hold the stack formed by the door striker 10, the outer side member 13, the central portion of the mounting bracket 14, and the mounting plate 11. Meanwhile, the mounting plate 14 to which the striker 10 and the mounting plate 11 are mounted is supported at ends thereof by the outer center pillar reinforcing member 12. The central portion of the mounting plate 14, however, is spaced away from the outer center pillar reinforcing member 12, and has an angle substantially different from the side wall angle of the outer center pillar reinforcing member 12.

The mounting bracket 14 is thus located in a space between the outer center pillar reinforcing member 12 and the outer side member 13. The space may be created between a side wall of the outer center pillar reinforcing member 12 and a side wall of the outer side member 13. Opposite lengthwise ends of the mounting bracket 14 are bonded to an outer surface of the outer center pillar reinforcing member 12, for example, through welding. A central portion of the mounting bracket 14 is attached to the outer side member 13, so as to contact an inner surface of the outer side member 13 in a region of the outer side member 13 in which an outer surface of the outer side member 13 contacts and supports the door striker 10.

The mounting plate 11 supporting the door striker 10 is not directly attached to the outer center pillar reinforcing member 12. Instead, the mounting plate 11 is attached to the mounting bracket 14, and the mounting bracket 14 is in turn attached to the outer center pillar reinforcing member 12.

As a result, the door striker 10 is directly supported by the outer side member 13 to which it is mounted, and is indirectly supported by the outer center pillar reinforcing member 12 via the mounting bracket 14 to which the door striker 10 is attached.

A bolt avoiding hole 17 can be formed in the outer center pillar reinforcing member 12, for example by burring a hole on a side wall of the outer center pillar reinforcing member 12. The bolt avoiding hole 17 may provide a space for an end of a bolt 16 used to couple the door striker 10 to the outer side member 13, the mounting bracket 14, and the mounting plate 11. The bolt avoiding hole 17 may thus prevent the bolt 16 from interfering with or otherwise contacting the outer center pillar reinforcing member 12. The bolt avoiding hole 17 is generally located along a principal axis of the bolt 16.

Accordingly, the door striker 10 is supported by the outer side member 13, while also being mounted to the mounting bracket 14. The door striker 10 is not directly mounted to or supported by the outer center pillar reinforcing member 12. Instead, the door striker 10 is separated and spaced away from a side wall of the outer center pillar reinforcing member 12, so that the door striker 10 can be free from design restrictions such as restrictions in effect to ensure proper opening/closing performance of the vehicle door.

As a result, the proper orientation and positioning of the door striker 10 necessary for proper functioning and latching of the vehicle door can be provided independently of the side wall angle of the outer center pillar reinforcing member 12. Hence, the outer center pillar reinforcing member 12 can be designed to any side wall angle, thereby making it possible to solve problems causing the generation of cracks or fissures in the member 12 and resulting from the limitations on side wall angles imposed by prior designs. The cracking and fissuring problems may be solved by improving the forming of the outer center pillar reinforcing member 12. Thus, a cross-section of the highly tensile cold formed outer center pillar reinforcing member 12 can be designed and formed without any restrictions on the side wall angle of the member.

In this way, according to the present disclosure, forming performance of an outer center pillar reinforcing member 12 can be improved by alleviating the requirements on a side wall angle of the outer center pillar reinforcing member 12. The requirements are alleviated by providing a structure in which the door striker is not mounted directly to the outer center pillar reinforcing member 12, but is spaced away from the outer center pillar reinforcing member 12. As such, requirements on the forming and shape of the outer center pillar reinforcing member 12 are alleviated, and the outer center pillar reinforcing member 12 can be formed of ultra-strong steel.

The door striker mounting apparatus according to the present disclosure can have the following advantages.

First, requirements that a side wall angle of the outer center pillar reinforcing member be within a designated range are relaxed by supporting the door striker using the outer side member, and by providing a separate mounting bracket fixed to the outer center pillar reinforcing member to support the door striker, and by allowing the supports for the door striker to be spaced away from the outer center pillar reinforcing member. Accordingly, specifications for the center pillar door striker part can be relaxed.

Second, a side wall angle of the outer center pillar reinforcing member can be varied by as much as 7°, making it possible to mass-produce highly tensile cooling formed center pillars for example using 980 MPa manufacturing processes. Thus, manufacturing costs and weight can be reduced.

Third, productivity of outer center pillar reinforcing members can be improved and gap quality of the door can be improved. That is, since the gap quality of the vehicle depends on the door striker mounting part, the quality of the vehicle body is lowered when a center pillar is not formed according to specifications. However, the gap quality can be controlled by using a separate mounting bracket that is produced according to detailed specifications, while relaxing specifications for the highly tensile center pillar.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A door striker mounting apparatus for a vehicle, the apparatus comprising:
a door striker disposed on an outer side member of a vehicle body;
a mounting bracket disposed between an outer center pillar reinforcing member of the vehicle body and the outer side member of the vehicle body,
wherein a central portion of the mounting bracket contacts a portion of the outer side member having the door striker disposed thereon; and
a mounting plate disposed on the mounting bracket so as to contact the central portion of the mounting bracket,
wherein the door striker, the outer side member, the central portion of the mounting bracket, and the mounting plate are attached together, and
wherein the central portion of the mounting bracket is spaced away from the outer center pillar reinforcing member.

2. The door striker mounting apparatus of claim 1, wherein the mounting bracket is disposed between the outer center pillar reinforcing member and the outer side member such that ends of the mounting bracket are bonded to the outer center pillar reinforcing member, and the central portion of the mounting bracket which contacts the outer side member is spaced away from the outer center pillar reinforcing member.

3. The door striker mounting apparatus of claim 1, further comprising:
a bolt for attaching the door striker, the outer side member, the central portion of the mounting bracket, and the mounting plate to each other,
wherein the outer center pillar reinforcing member includes a bolt avoiding hole formed in the outer center pillar reinforcing member and lined up with a principal axis of the bolt.

4. The door striker mounting apparatus of claim 2, further comprising:
a bolt for attaching the door striker, the outer side member, the central portion of the mounting bracket, and the mounting plate to each other,
wherein the outer center pillar reinforcing member includes a bolt avoiding hole formed in the outer center pillar reinforcing member and lined up with a principal axis of the bolt.
